(19) United States
(12) Patent Application Publication
(10) Pub. No.: US 2005/0166830 A1
(43) Pub. Date: Aug. 4, 2005

(54) Analog speedometer with selectable scaling

(76) Inventor: James P. Wylin, Waterford, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/767,826

(22) Filed: Jan. 29, 2004

(51) Int. Cl. G01P 1/02; G01P 5/00

(52) U.S. Cl. 116/62.1; 73/493

(57) ABSTRACT

An analog speedometer with user selectable scaling is provided. The speedometer has a signal input for receiving vehicle speed information, a scaling indicator for indicating a selected one of a set of predetermined scalings, and a positionable pointer. A dial face has magnitude indicia proximate to the positionable pointer, and the pointer is uniquely positioned according to the vehicle speed information and the selected one of the set of predetermined scalings. A scaled vehicle speed is indicated by the unique position of the pointer.

### FIELD OF INVENTION

This application relates generally to analog gauges for indicating velocity, and more particularly to such gauges wherein the scaling of the indication may be selected by a user.

### BACKGROUND

Practically all vehicles include a speedometer for indicating the vehicle's speed, or distance per unit of time. The distance per unit time is commonly referred to as the scaling of the speedometer. Common scaling includes mile per hour (MPH) and kilometer per hour (km/h).

A modern analog speedometer operates by receiving a signal directly or indirectly from a sensing device and then positioning a pointer in response to the signal. Examples of common sensing devices include a toothed wheel and hall effect sensor arrangement located at a vehicle wheel, or a similar arrangement located at the output shaft of the vehicle's transmission. The signal is generally an electrical pulse train having a frequency proportional to the angular velocity of the toothed wheel or shaft. Once the speedometer has positioned the pointer in response to the signal, a printed dial face generally positioned under the pointer is used to indicate the vehicle speed in a common scaling, such as MPH or km/H.

An undesirable aspect of the aforementioned design is that different printed dial faces are required for different speedometers to be used in different political regions. For example, speedometers intended for use in the United States have dial faces scaled in MPH, whereas those intended for use in Canada have dial faces scaled in km/h. This difference in scaling in the dial faces often causes manufacturers of vehicles to maintain an inventory of at least two speedometer assemblies. One for installation in vehicles to be sold in a first political region and another for vehicles to be sold in a political region which uses a different scaling. In addition to the undesirability of maintaining inventory of at least two speedometer versions, vehicle manufacturers also must be vigilant to prevent misbuilding a vehicle by installing a speedometer with the wrong scaling for the intended market.

### SUMMARY OF INVENTION

Accordingly, an aspect of the invention is to provide an analog speedometer having selectable scaling.

In accordance with this aspect, an analog speedometer with user selectable scaling is provided. The speedometer has a signal input for receiving vehicle speed information, a scaling indicator for indicating a selected one of a set of predetermined scalings, and a positionable pointer. A dial face has magnitude indicia proximate to the positionable pointer, and the pointer is uniquely positioned according to the vehicle speed information and the selected one of the set of predetermined scalings. A scaled vehicle speed is indicated by the unique position of the pointer.

### BRIEF DESCRIPTION OF THE DRAWINGS

FIG. 1 illustrates a speedometer of the prior art;

FIG. 2 illustrates a speedometer having changeable scaling; and

FIG. 3 is a method for selecting predetermined scalings.

### DETAILED DESCRIPTION

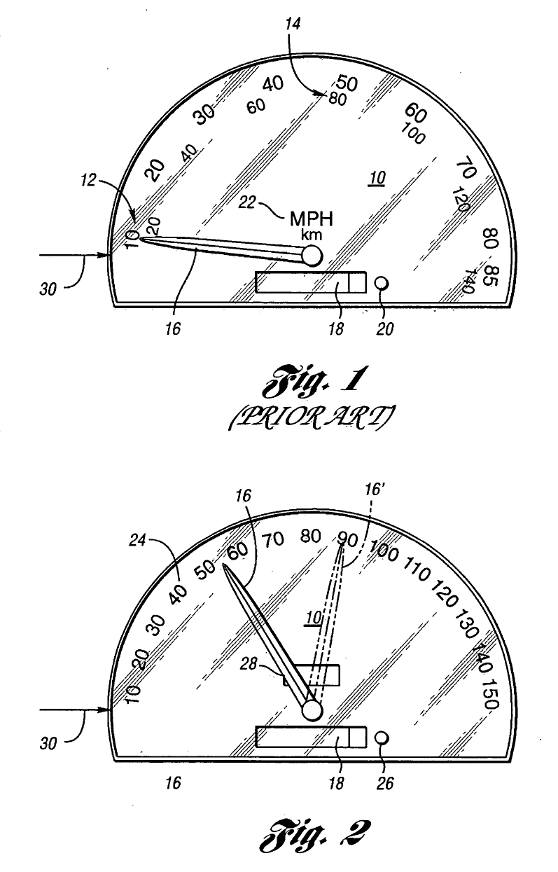

Turning now to FIG. 1, a prior art speedometer is shown. The speedometer receives a signal via signal input 30. The signal has a fixed unit format and may be a pulse train having a frequency corresponding to the vehicle speed, or it may be a network message containing vehicle speed information. In either case, the scaling of the signal is fixed and must be converted by positioning the pointer 16. An electrical circuit known in the art positions the pointer 16 in response to the signal frequency or vehicle speed information. Over the range of possible needle positions, a one-to-one correlation exists between the signal frequency or information and the resultant needle position.

A dial face 10 is positioned under the needle 16. A set of primary indicia 12 are located on the dial face 10 and represent the vehicle speed in a primary scaling, for example MPH. A set of secondary indicia 14 are also located on the dial face and represent the vehicle speed in a secondary scaling, for example km/h. A legend 22 informs the speedometer user of the scaling of the primary and secondary indicia. A trip odometer 18 is also located in the dial face and a button 20 is provided for resetting the trip odometer 18.

To convert the needle position to a vehicle speed of common scaling, the speedometer user reads the indicia value located under the pointer 16 at any given time. If the pointer does not fall directly on an indicium, then the user must interpolate a value between the two nearest indicia. As an example, the pointer in FIG. 1 is indicating a vehicle speed of approximately 55 MPH or 89 km/h, depending on the desired scaling.

An undesirable aspect of the prior art speedometer is that the dial face presents two sets of indicia. If both indicia were of similar size to facilitate legibility, a user may incorrectly interpret the vehicle speed when glancing at the speedometer. To reduce this possibility, the primary indicia are generally rendered in a conspicuous font, and the secondary indicia are generally rendered in a less conspicuous font. However, this simple solution to differentiating the primary and secondary indicia does not solve the problem of needing speedometers with different dial faces depending on the common scaling of the political area in which the speedometer will primarily be used. This is because the primary indicia and secondary indicia are fixed and their prominence cannot be altered depending on the desired scaling. Furthermore, the less-conspicuous secondary scaling may not be satisfactorily visible to some speedometer users.

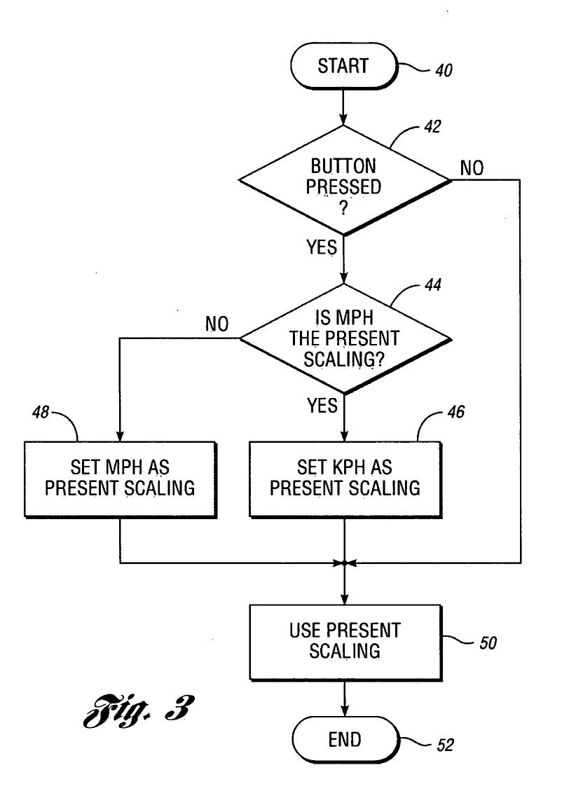

Referring now to FIG. 2, an analog speedometer having user-selectable scaling is shown. By pressing button 26, a user may select a desired scaling from a set of predetermined scalings stored in the speedometer circuitry. An example of a set of predetermined scalings includes MPH and km/h. The selected scaling is displayed by scaling indicator 28, such as an LCD display incorporated into the speedometer unit. Like the speedometer of FIG. 1, the speedometer receives a signal via signal input 30. The signal has a fixed unit format and may be a pulse train having a frequency corresponding to the vehicle speed, or it may be a network message containing vehicle speed information. In either case, the scaling of the signal is fixed and must be converted by positioning the pointer 16. An electrical circuit positions pointer 16 in response the signal frequency or vehicle speed information. Over the range of possible needle positions, a one-to-one correlation exists between the signal frequency or information and the resultant needle position for each predetermined scaling.

Turning briefly to FIG. 3, a method for selecting a desired scaling from a set of predetermined scalings is shown. The method may be executed periodically to poll whether button 26 is pressed, or may be executed on an interrupt generated by button 26. Beginning at step 40, the method proceeds to decision block 42 where it is determined whether button 26 is pressed. If not, the method exits through block 50 and without changing the scaling. If button 26 is pressed in decision block 42, the method proceeds to decision block 44 to determine whether the present scaling is MPH. If so, then the method proceeds to use another predetermined scaling, such as km/h, in block 46. From block 46, the method exits through block 50 and uses km/h as the present scaling. Returning to block 44, if the present scaling is not MPH, then the method proceeds to block 48 and sets MPH as the present scaling. The method then exits through block 50, using MPH as the present scaling.

Returning to FIG. 2, the speedometer has a dial face 10 with magnitude indicia 24 applied thereon in a pattern where each of magnitude indicia 24 is associated with a position of a movable pointer 16. The dial face 10 may also provide for an odometer 18. The button 26 and odometer 18 may also be remotely located from the faceplate 10.

In operation, the vehicle speed signal appears in a fixed unit format at signal input 30. The pointer 16 assumes a position dependent upon the vehicle speed information in the vehicle speed signal. The position depends upon the scaling selected by the user. For example, assume the actual vehicle speed is 55 MPH. If the selected scaling is MPH, then the pointer 16 will be positioned as shown in FIG. 2. If, however, the selected scaling is km/h, then pointer 16 would instead assume position 16′ since 55 MPH is approximately equal to 89 km/h. With the improved speedometer of FIG. 2, the vehicle speed indicia are always provided in a conspicuous font regardless of the selected scaling. Similarly, scaling indicator 28 always provides a conspicuous indication of the selected scaling. The undesirable aspects of the prior art are thereby overcome.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An analog speedometer with user selectable scaling, the speedometer comprising:
a signal input for receiving vehicle speed information;
a scaling indicator for indicating a selected one of a set of predetermined scalings;
a positionable pointer; and
a dial face having magnitude indicia proximate to said positionable pointer, said pointer being uniquely positioned according to said vehicle speed information and said selected one of said set of predetermined scalings, whereby a scaled vehicle speed is indicated by the unique position of said pointer.

2. The analog speedometer of claim 1 further comprising a button for selecting said one of said set of predetermined scalings.

3. The analog speedometer of claim 1 wherein said set of predetermined scalings further comprises MPH and km/h.

4. A method for positioning a pointer in an analog speedometer, said method comprising:
receiving a vehicle speed signal;
determining a selected scaling from a set of predetermined scalings;
uniquely positioning the pointer as a function of said vehicle speed signal and said selected scaling.

5. The method of claim 4 wherein said step of determining a selected scaling further comprises detecting the press of a scaling selection button.

6. The method of claim 4 wherein said step of determining a selected scaling further comprises determining said selected scaling from a set of predetermined scalings including MPH and km/h.
